(19) United States
(12) Patent Application Publication
(10) Pub. No.: US 2014/0214694 A1
(43) Pub. Date: Jul. 31, 2014

(54) METHOD AND APPARATUS FOR MANAGING GROUP WORKSPACES

(71) Applicant: Electronics and Telecommunications Research Institute, Daejeon (KR)

(72) Inventors: Young Mee SHIN, Daejeon (KR); Hyun Joo BAE, Daejeon (KR)

(73) Assignee: ELECTRONICS AND TELECOMMUNICATIONS RESEARCH INSTITUTE, Daejeon (KR)

(21) Appl. No.: 14/088,357

(22) Filed: Nov. 23, 2013

(30) Foreign Application Priority Data
Jan. 31, 2013 (KR) 10-2013-0011422

(51) Int. Cl. G06Q 10/10

(52) U.S. Cl. CPC G06Q 10/103
USPC 705/301

(57) ABSTRACT

When a workspace management apparatus for a group receives a request message for group management from a client terminal, the workspace management apparatus manages a group in a first service according to the request message and requests workspace management for a group from a plurality of servers that each provides other services different from the first service.

### CROSS-REFERENCE TO RELATED APPLICATION

This application claims priority to and the benefit of Korean Patent Application No. 10-2013-0011422 filed in the Korean Intellectual Property Office on Jan. 31, 2013, the entire contents of which are incorporated herein by reference.

### BACKGROUND OF THE INVENTION

(a) Field of the Invention

The present invention relates to a method and apparatus for managing group workspaces. More particularly, the present invention relates to a method and apparatus for efficiently managing group workspaces within other individual services based on a social network.

(b) Description of the Related Art

With the spread of smart work, social network services, file cloud services, and wiki services are used a lot for businesses, and particularly, group collaboration services such as communication, file sharing, and online document collaboration writing for specific task related persons have been frequently used. In such a case, in presently individually provided social network services, file cloud services, and wiki services, group generation, deletion, and change are not mutually interlocked and thus a user belonging to a group should directly perform a group generation and deletion and change work for each individual service.

That is, for a communication space of a group, a user should access a social network service, generate a group, and add members to the group. Further, in order for the same group to share a file, the user should access a file cloud service, make a sharing folder, and invite members. In order for the same group to share a wiki page, the user should access a wiki service, make a wiki container for the group, and give wiki container access authority to each member. In a situation in which a business group dynamically frequently appears and disappears, inconvenience in which the user should access an individual service and manage the group every time occurs.

Conventionally, there have been many examples of interlocking a social network service and another service. However, most conventional services were used for custom-made advertisements or recommendations using social network personal relationship information or profile, or for fast diffusion and sharing of contents using personal relationship information of a social network.

In an individual providing business services such as social network services, file cloud services, and wiki services, a method of efficiently managing group workspaces is needed.

### SUMMARY OF THE INVENTION

The present invention has been made in an effort to provide a method and apparatus for managing group workspaces having advantages of efficiently managing group workspaces in different business services.

An exemplary embodiment of the present invention provides an apparatus for managing workspaces for a group. The group workspace management apparatus includes a message analysis unit, a group management unit, and a group interlock unit. The message analysis unit receives a request message for group management from a client terminal. The group management unit manages a group in a first service according to the request message. The group interlock unit requests workspace management for the group from at least one server of a plurality of servers that provide other services different from the first service according to the request message.

The group management may include at least one of group generation, group change, and group deletion, and the workspace management may include at least one of workspace generation, workspace change, and workspace deletion.

The group interlock unit may include a plurality of interlock plug-ins that support interlocking with the plurality of servers, respectively.

The group interlock unit may inquire whether to interlock the group management with the plurality of servers to a client terminal, and request workspace management with only servers to which the client terminal consents to interlock among the plurality of servers.

The group interlock unit may set an interlock flag value of a server to which the client terminal consents to interlock to a first value and set an interlock flag value of a server to which the client terminal does not consent to interlock to a second value different from the first value.

The first service may be a social network service, and the second service may include at least one of a file cloud service and a wiki service.

When the request message is a request message for group generation, the group management unit may generate a group in the first service, and the group interlock unit may request workspace generation of the group from the at least one server of the other service and request to allow access to the workspace to users of the group.

When the request message is a request message for group deletion, the group management unit may delete a corresponding group in the first service, and the group interlock unit may request workspace deletion of the corresponding group to the at least one server.

When the request message is a request message for group change, the group management unit may change users of a corresponding group in the first service, and the group interlock unit may request to change users to access workspace of the corresponding group from the at least one server.

Another embodiment of the present invention provides a method of managing workspaces of a workspace management apparatus for a group. The method includes: receiving a request message for group management from a client terminal; managing a group in a first service according to the request message; and requesting workspace management for the group from at least one of a plurality of servers that each provide other services different from the first service according to the request message.

The group management may include group generation, the managing of a group may include generating a group in the first service, and the requesting of workspace management may include requesting generation of workspace from at least one server of the plurality of servers.

The requesting of workspace management may further include requesting to allow access to the workspace for group members from the at least one server.

The group management may include group change, the managing of a group may include changing users of the group in the first service, and the requesting of workspace management may include changing users to access to a corresponding workspace from at least one server of the plurality of servers.

The group management may include group deletion, the managing of a group may include deleting the group in the first service, and the requesting of workspace management may include requesting deletion of a corresponding workspace from at least one server of the plurality of servers.

The requesting of deletion may include: inquiring whether to delete workspace of the group in the plurality of servers from the client terminal; and requesting, by the client terminal of the plurality of servers, deletion of workspace of a server that consents to deletion of the workspace.

The requesting of workspace management may include requesting workspace management for the group from the at least one server through an open application programming interface (API).

### BRIEF DESCRIPTION OF THE DRAWINGS

FIG. 1 is a block diagram illustrating a group workspace management apparatus according to an exemplary embodiment of the present invention.

FIG. 2 is a block diagram illustrating the group workspace management apparatus of FIG. 1.

FIG. 3 is a flowchart illustrating a method of managing group workspaces according to an exemplary embodiment of the present invention.

FIG. 4 is a flowchart illustrating a method of generating and interlocking a group according to an exemplary embodiment of the present invention.

FIG. 5 is a flowchart illustrating a method of changing and interlocking a group according to an exemplary embodiment of the present invention.

FIG. 6 is a flowchart illustrating a method of adding and interlocking a group member according to an exemplary embodiment of the present invention.

FIG. 7 is a flowchart illustrating a method of deleting and interlocking a group member according to an exemplary embodiment of the present invention.

FIG. 8 is a flowchart illustrating a method of deleting and interlocking a group according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for managing group workspaces according to an exemplary embodiment of the present invention will be described in detail with reference to the drawings.

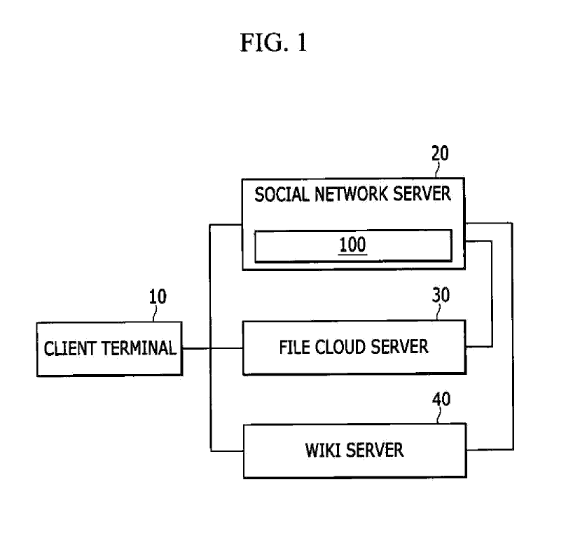

FIG. 1 is a block diagram illustrating a group workspace management apparatus according to an exemplary embodiment of the present invention.

Referring to FIG. 1, a group workspace management apparatus 100 mutually interlocks group generation, deletion, and change in an individually provided social network service, file cloud service, and wiki service.

The group workspace management apparatus 100 may be embodied in one of a social network server 20 that provides a social network service, a file cloud server 30 that provides a file cloud service, and a wiki server 40 that provides a wiki service.

In FIG. 1, the group workspace management apparatus 100 operates based on a social network and is embodied in the social network server 20.

A client terminal 10 may include a web browser or a mobile App for accessing the social network server 20, the file cloud server 30, and the wiki server 40.

The group workspace management apparatus 100 performs an original function of a social network service and a group interlock function. The original function of the social network service may include a message receiving function, a social message processing function, and a social group management function.

The file cloud server 30 and the wiki server 40 manage workspaces of a corresponding group in a file cloud service and a wiki service by a group interlock function of the group workspace management apparatus 100.

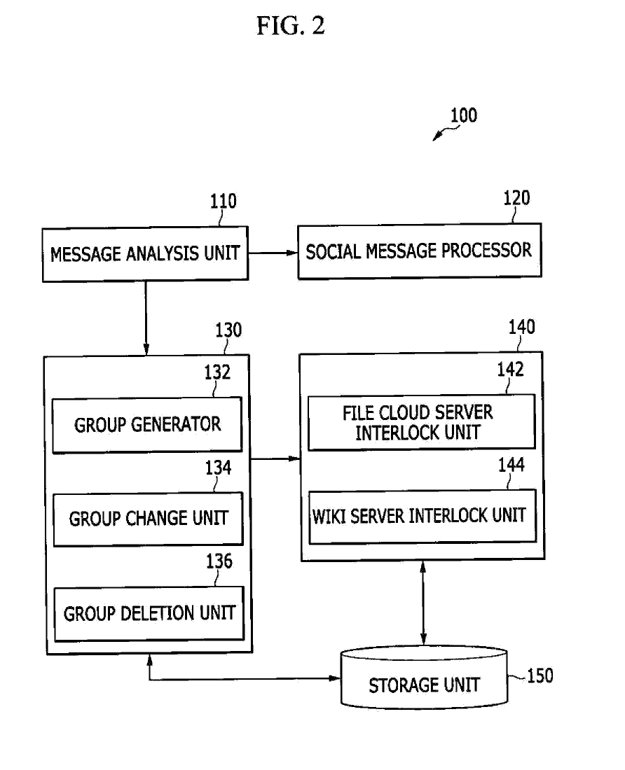

FIG. 2 is a block diagram illustrating the group workspace management apparatus of FIG. 1.

Referring to FIG. 2, the group workspace management apparatus 100 includes a message analysis unit 110, a social message processor 120, a group management unit 130, a group interlock unit 140, and a storage unit 150.

The message analysis unit 110 analyzes a received message. The message analysis unit 110 analyzes whether the received message is a group management request message. If the received message is not a group management request message, the received message is a social network service related message and thus the message analysis unit 110 forwards the received message to the social message processor 120. The group management request message includes a group generation request message, a group change request message, and a group deletion request message.

The social message processor 120 processes a received social network service related message.

The group management unit 130 generates, changes, and deletes a group according to a group management request message. The group management unit 130 includes a group generator 132, a group change unit 134, and a group deletion unit 136. The group generator 132 generates a group according to a group generation request message. The group change unit 134 changes a group according to a group change request message. The group deletion unit 136 deletes a group according to a group deletion request message.

The group interlock unit 140 determines whether to interlock a group with the file cloud server 30 and the wiki server 40, and requests generation, change, and deletion of workspace of a corresponding group within the file cloud server 30 and the wiki server 40 according to group generation, group change, and group deletion of the group management unit 130. That is, the file cloud server 30 and the wiki server 40 manage a workspace of a corresponding group according to a request from the group interlock unit 140.

The group interlock unit 140 includes a file cloud server interlock unit 142 that supports group interlock with the file cloud server 30, and a wiki server interlock unit 144 that supports group interlock with the wiki server 40.

The file cloud server interlock unit 142 and the wiki server interlock unit 144 may include a file cloud interlock plug-in and a wiki interlock plug-in for interlocking with the file cloud server 30 and the wiki server 40, respectively.

The file cloud server interlock plug-in and the wiki server interlock plug-in request generation, change, and deletion of workspace of a corresponding group to the file cloud server 30 and the wiki server 40 through an open application programming interface (API).

The file cloud server 30 and the wiki server 40 process an open API request from the file cloud server interlock unit 142 and the wiki server interlock unit 144.

The storage unit 150 stores social group information, file cloud interlock flag information, and wiki interlock flag information. The social group information includes a group identifier, a group name, and a group member list. The file cloud interlock flag represents whether to reflect a social group to the file cloud server 30. The wiki interlock flag represents whether to reflect a social group to the wiki server 40.

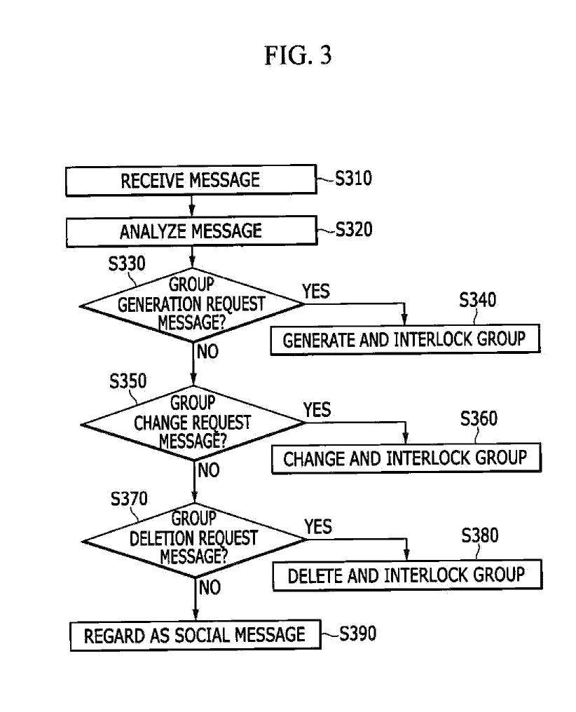

FIG. 3 is a flowchart illustrating a method of managing group workspaces according to an exemplary embodiment of the present invention.

Referring to FIG. 3, when the message analysis unit 110 of the group workspace management apparatus 100 receives a message from the client terminal 10 (S310), the message analysis unit 110 analyzes the received message (S320).

The message analysis unit 110 determines whether the received message is a group generation request message (S330), and if the received message is a group generation request message, the message analysis unit 110 forwards the group generation request message to the group generator 132 of the group management unit 130.

The group generator 132 performs a process of generating a group according to the group generation request message and interlocking group generation with the file cloud server 30 and the wiki server 40 (S340).

The message analysis unit 110 determines whether the received message is a group change request message (S350), and if the received message is a group change request message, the message analysis unit 110 forwards a group change request message to the group change unit 134 of the group management unit 130.

The group change unit 134 performs a process of changing a group according to the group change request message and interlocking group change with the file cloud server 30 and the wiki server 40 (S360).

The message analysis unit 110 determines whether the received message is a group deletion request message (S370), and if the received message is a group deletion request message, the message analysis unit 110 forwards the group deletion request message to the group deletion unit 136 of the group management unit 130.

The group deletion unit 136 performs a process of deleting a group according to the group deletion request message and interlocking group deletion with the file cloud server 30 and the wiki server 40 (S380).

If the received message is not a group management request message including the group generation request message, the group change request message, and the group deletion request message, the received message is regarded as a social network service related message and is processed by the social message processor 120 (S390).

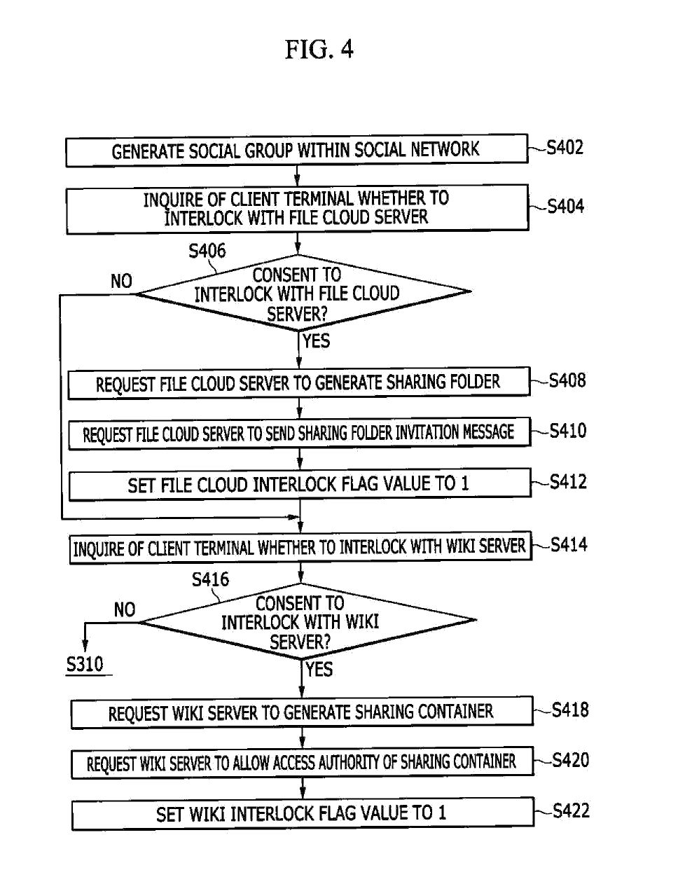

FIG. 4 is a flowchart illustrating a method of generating and interlocking a group according to an exemplary embodiment of the present invention.

Referring to FIG. 4, when a message is a group generation request message, a group generation and interlock process is performed.

The group generator 132 generates a social group within a social network according to the group generation request message (S402), and generates social group information including a group identifier, a group name, and a group member list.

The file cloud server interlock unit 142 inquires of the client terminal 10 whether to interlock with the file cloud server 30(S404).

The file cloud server interlock unit 142 determines whether the client terminal 10 consents to interlock with the file cloud server 30 (S406), and if the client terminal 10 consents to interlock with the file cloud server 30, the file cloud server interlock unit 142 requests the file cloud server 30 to generate a sharing folder (S408), and requests the file cloud server 30 to send a sharing folder invitation message to group members (S410).

Thereafter, the file cloud server interlock unit 142 sets a file cloud interlock flag value to a value representing interlock (S412). In this case, a value representing interlock may be numerals such as 0 or 1 or may be text such as true. For convenience of description, it is assumed that a value representing interlock is 1.

In this way, when a group interlock process with the file cloud server 30 is complete, a group interlock process with the wiki server 40 is started.

The wiki server interlock unit 144 inquires of the client terminal 10 whether to interlock with the wiki server 40 (S414).

The wiki server interlock unit 144 determines whether the client terminal 10 consents to interlock with the wiki server 40 (S416) and if the client terminal 10 consents to interlock with the wiki server 40, the wiki server interlock unit 144 requests the wiki server 40 to generate a sharing container (S418) and requests the wiki server 40 to allow access authority of a sharing container to group members (S420).

Thereafter, the wiki server interlock unit 144 sets a wiki interlock flag value to 1 (S422).

If the client terminal 10 does not consent to interlock with the wiki server 40, the process continues at the step of receiving a message (S310 of FIG. 3).

Unlike the case of FIG. 4, a group interlock process with the wiki server 40 may first be performed, and an interlock process with the file cloud server 30 may then be performed.

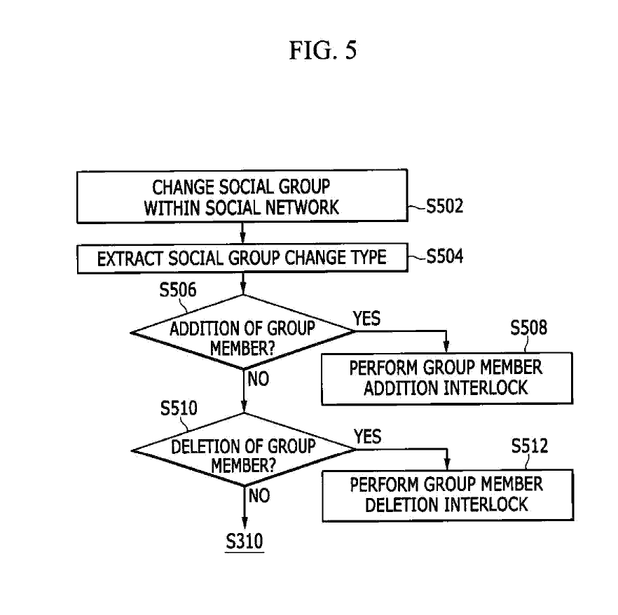

FIG. 5 is a flowchart illustrating a method of changing and interlocking a group according to an exemplary embodiment of the present invention.

Referring to FIG. 5, when the message is a group change request message, a group change and interlock process is performed.

The group change unit 134 changes a social group within a social network according to a group change request message (S502) and extracts a social group change type (S504).

The group interlock unit 140 determines whether the social group change type is addition of a group member (S506), and if the social group change type is addition of a group member, the group interlock unit 140 performs a group member addition interlock process (S508).

The group interlock unit 140 determines whether the social group change type is deletion of a group member (S510), and if the social group change type is deletion of a group member, the group interlock unit 140 performs a group member deletion interlock process (S512).

If a social group change type is not addition or deletion of a group member, the process continues at the step of receiving a message (S310 of FIG. 3).

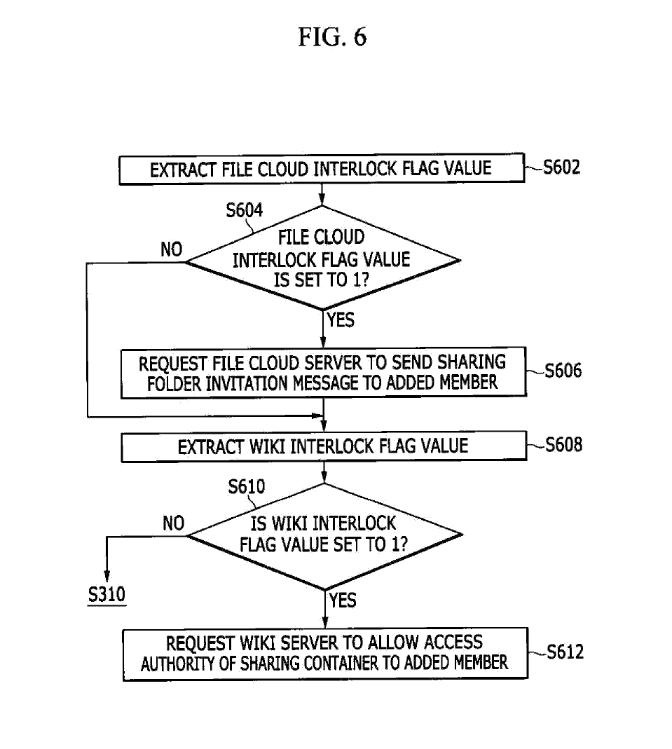

FIG. 6 is a flowchart illustrating a method of adding and interlocking a group member according to an exemplary embodiment of the present invention.

Referring to FIG. 6, the file cloud server interlock unit 142 extracts a file cloud interlock flag value of social group information (S602).

The file cloud server interlock unit 142 determines whether the file cloud interlock flag value is set to 1 (S604), and if the file cloud interlock flag value is set to 1, the file cloud server interlock unit 142 requests the file cloud server 30 to send a sharing folder invitation message to an added member (S606).

Next, the wiki server interlock unit 144 extracts a wiki interlock flag value of social group information (S608).

The wiki server interlock unit 144 determines whether the wiki interlock flag value is set to 1 (S610), and if the wiki interlock flag value is set to 1, the wiki server interlock unit 144 requests the wiki server 40 to allow access authority of a sharing container to an added member (S612).

If a wiki interlock flag value is not set to 1, the process continues at the step of receiving a message (S310 of FIG. 3).

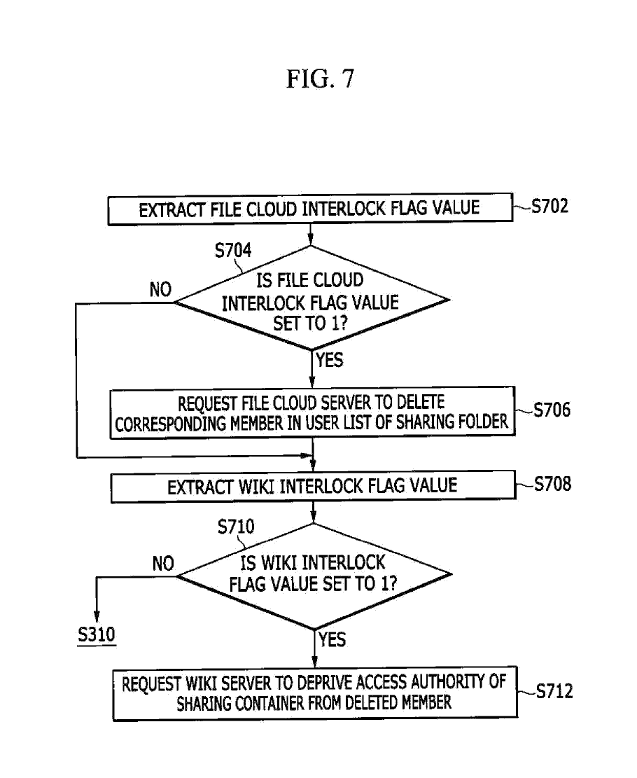

FIG. 7 is a flowchart illustrating a method of deleting and interlocking a group member according to an exemplary embodiment of the present invention.

Referring to FIG. 7, the file cloud server interlock unit 142 extracts a file cloud interlock flag value of social group information (S702).

The file cloud server interlock unit 142 determines whether the file cloud interlock flag value is set to 1 (S704), and if the file cloud interlock flag value is set to 1, the file cloud server interlock unit 142 requests the file cloud server 30 to delete a corresponding member in a user list of a sharing folder (S706).

Next, the wiki server interlock unit 144 extracts a wiki interlock flag value of social group information (S708).

The wiki server interlock unit 144 determines whether the wiki interlock flag value is set to 1 (S710), and if the wiki interlock flag value is set to 1, the wiki server interlock unit 144 requests the wiki server 40 to deprive access authority of a sharing container from a deleted member (S712).

When a wiki interlock flag value is not set to 1, the process continues at the step of receiving a message (S310 of FIG. 3).

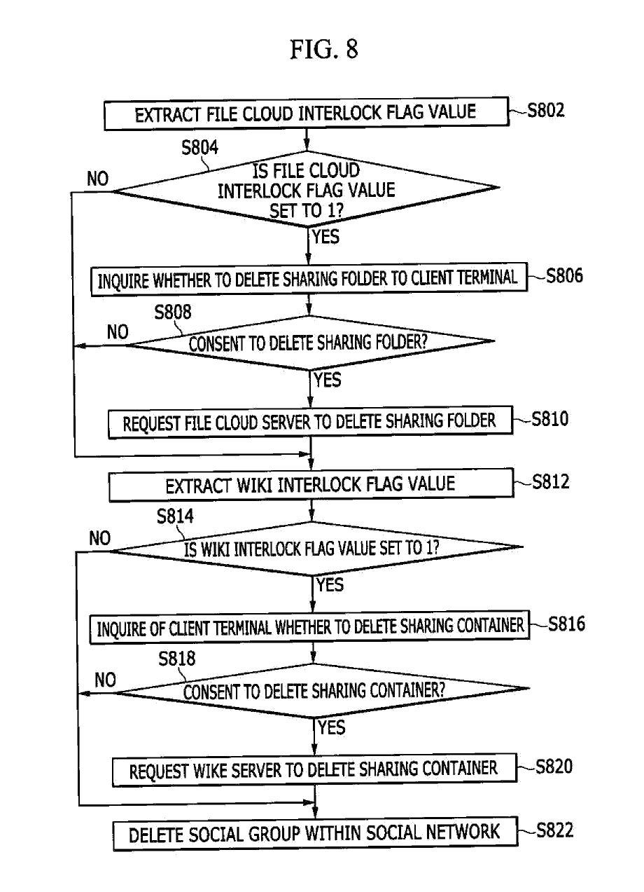

FIG. 8 is a flowchart illustrating a method of deleting and interlocking a group according to an exemplary embodiment of the present invention.

Referring to FIG. 8, when the message is a group deletion request message, a group deletion and interlock process is performed.

The file cloud server interlock unit 142 extracts a file cloud interlock flag value of social group information (S802).

The file cloud server interlock unit 142 determines whether the file cloud interlock flag value is set to 1 (S804), and if the file cloud interlock flag value is set to 1, the file cloud server interlock unit 142 inquires of the client terminal 10 whether to delete a sharing folder of the file cloud server 30 (S806).

The file cloud server interlock unit 142 determines whether the client terminal 10 consents to delete the sharing folder (S808), and if the client terminal 10 consents to delete the sharing folder, the file cloud server interlock unit 142 requests the file cloud server 30 to delete the sharing folder (S810).

Next, the wiki server interlock unit 144 extracts a wiki interlock flag value of social group information (S812).

The wiki server interlock unit 144 determines whether the wiki interlock flag value is set to 1 (S814), and if the wiki interlock flag value is set to 1, the wiki server interlock unit 144 inquires of the client terminal 10 whether to delete a sharing container of the wiki server 40 (S816).

The wiki server interlock unit 144 determines whether the client terminal 10 consents to delete the sharing container (S818), and if the client terminal 10 consents to delete the sharing container, the wiki server interlock unit 144 requests the wiki server 40 to delete the sharing container (S820).

Next, the group deletion unit 136 deletes a social group (S822). If the client terminal 10 does not consent to delete the sharing container, the group deletion unit 136 may delete only a social group.

According to an exemplary embodiment of the present invention, in an individually provided business service like a social network service, a file cloud service, and a wiki service, by mutually interlocking generation, deletion, and change of group workspaces, inconvenience in which group users should generate, delete, and change group workspace in an individual server can be solved.

Further, for group interlock, because the group workspace management apparatus is formed in a plug-in structure, the group workspace management apparatus can be easily interlocked with a new server.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for managing workspaces for a group the apparatus comprising:
a message analysis unit that receives a request message for group management from a client terminal;
a group management unit that manages a group in a first service according to the request message; and
a group interlock unit that requests workspace management for the group from at least one server of a plurality of servers that each provide other services different from the first service according to the request message.

2. The apparatus of claim 1, wherein the group management comprises at least one of group generation, group change, and group deletion, and
the workspace management comprises at least one of workspace generation, workspace change, and workspace deletion.

3. The apparatus of claim 1, wherein the group interlock unit comprises a plurality of interlock plug-ins that support interlocking with the plurality of servers, respectively.

4. The apparatus of claim 1, wherein the group interlock unit inquires whether to interlock the group management with the plurality of servers to a client terminal, and requests workspace management with only servers to which the client terminal consents to interlock among the plurality of servers.

5. The apparatus of claim 4, wherein the group interlock unit sets an interlock flag value of a server to which the client terminal consents to interlock to a first value and sets an interlock flag value of a server to which the client terminal does not consent to interlock to a second value different from the first value.

6. The apparatus of claim 1, wherein the first service is a social network service, and the second service comprises at least one of a file cloud service and a wiki service.

7. The apparatus of claim 1, wherein when the request message is a request message for group generation,
the group management unit generates a group in the first service, and
the group interlock unit requests workspace generation of the group from the at least one server of the other service and requests to allow access to the workspace to users of the group.

8. The apparatus of claim 1, wherein when the request message is a request message for group deletion,
the group management unit deletes a corresponding group in the first service, and
the group interlock unit requests workspace deletion of the corresponding group from the at least one server.

9. The apparatus of claim 1, wherein when the request message is a request message for group change,
the group management unit changes users of a corresponding group in the first service, and
the group interlock unit requests to change users to access workspace of the corresponding group from the at least one server.

10. A method of managing workspaces of a workspace management apparatus for a group, the method comprising:
receiving a request message for group management from a client terminal;
managing a group in a first service according to the request message; and
requesting workspace management for the group from at least one of a plurality of servers that each provide other services different from the first service according to the request message.

11. The method of claim 10, wherein the group management comprises group generation,
the managing of a group comprises generating a group in the first service, and
the requesting of workspace management comprises requesting generation of workspace from at least one server of the plurality of servers.

12. The method of claim 11, wherein the requesting of workspace management further comprises requesting to allow access to the workspace for group members from the at least one server.

13. The method of claim 10, wherein the group management comprises group change,
the managing of a group comprises changing users of the group in the first service, and
the requesting of workspace management comprises changing users to access to a corresponding workspace from at least one server of the plurality of servers.

14. The method of claim 10, wherein the group management comprises group deletion,
the managing of a group comprises deleting the group in the first service, and
the requesting of workspace management comprises requesting deletion of a corresponding workspace from at least one server of the plurality of servers.

15. The method of claim 14, wherein the requesting of deletion comprises:
inquiring whether to delete workspace of the group in the plurality of servers to the client terminal; and
requesting, by the client terminal of the plurality of servers, deletion of workspace of a server that consents to deletion of the workspace.

16. The method of claim 10, wherein the requesting of workspace management comprises requesting workspace management for the group from the at least one server through an open application programming interface (API).

17. The method of claim 10, wherein the first service is a social network service, and the second service comprises at least one of a file cloud service and a wiki service.
